(19) United States
(12) Patent Application Publication
(10) Pub. No.: US 2015/0232959 A1
(43) Pub. Date: Aug. 20, 2015

(54) INTERLOCKING STRUCTURE WITH INTEGRATED SECURING REGIONS FOR HEAT TREATING METAL PARTS

(71) Applicant: Schunk Graphite Technology, LLC, Menomonee Falls, WI (US)

(72) Inventors: Alicia Faye Walters, Grayslake, IL (US); William Scott Warwick, Menomonee Falls, WI (US); Jason Gahagan, Menomonee Falls, WI (US); Thorsten Scheibel, Heuchelheim (DE)

(73) Assignee: SCHUNK GRAPHITE TECHNOLOGY, LLC, Menomonee Falls, WI (US)

(21) Appl. No.: 14/180,995

(22) Filed: Feb. 14, 2014

(51) Int. Cl. C21D 9/00; F27D 5/00

(52) U.S. Cl. CPC C21D 9/0025; F27D 5/0006

(57) ABSTRACT

Disclosed herein is an interlocking structure. Method(s) of making, assembling and/or using the structure are also disclosed. In accordance with least some embodiments, the structure includes: a frame; a plurality of first members arranged approximately parallel to each other and secured to the frame, each first member comprising a body, a plurality of slots and a plurality of raised teeth; a plurality of second members arranged approximately parallel to each other and secured to the frame, each second member comprising a body, a plurality of slots and, optionally, a plurality of raised teeth, wherein the slots of the first members correspond to and interlock with the slots of the second members such that the first and second members intersect; and a plurality of securing regions, each securing region comprising a raised tooth. The frame, at least one first member and/or at least one second member can comprise a carbon fiber composite material.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

The present disclosure relates to structures to secure metal parts for heat treatment and, more particularly, to an interlocking grid structure with integrated securing regions for securing metal parts during heat treatment.

### BACKGROUND

When heat treating metal parts, such as transmission gears, large numbers of parts are placed on a structure and subject to the heat treating process. The parts need to be placed such that they are secured to the structure, prevented from shifting during transport, and not in physical contact with each other. Because the outer surface of the metal parts is most important, it is preferred to secure the parts using an inner void/aperture, if the part has one. In other words, the less contact between the structure and the outer surface of the parts, the better. Typically, for structures which secure parts for heat treatment, and specifically parts with an inner void/aperture, the structures include a plurality of pins or pin-like structures having outer dimensions corresponding to the inner dimensions of the void/aperture of the parts.

In addition to properly securing the parts, the structure must also be able to withstand multiple heat treatment cycles and not distort over time. Many heat treating processes, particularly in manufacture and factory settings, are automated, and the structures used to secure the parts are reused. The material used to make the structure must be durable and not distort, warp or otherwise weaken after exposure to multiple heat treatment cycles.

Currently, two materials are typically used for structures that secure parts during heat treatment processes, namely: (1) carbon fiber composite and (2) metal alloys. Each has advantages and disadvantages in light of the above considerations.

Carbon fiber composite is typically used for structures subjected to multiple heat treatment cycles. As used herein, a “composite material” is a material that is made of two or more components. Carbon fiber composite structures show less wear, e.g., distortion, warping and/or weakening, compared to metal alloy structures after exposure to several heat treatment cycles. In addition, the weight of carbon fiber composite structures is less than similar structures made of metal alloys, and in some instances, can provide a reduction in weight of 80% or more. The reduced weight of the carbon fiber composite structures provides faster heating and quenching, which is important for achieving a good hardness profile and also energy savings.

However, the nature of carbon fiber composite makes it ill-suited for securing parts by an internal void/aperture. Current carbon fiber composite structures start as a flat plate or grid machined from the composite, and individual holes are bored into the plate to secure pegs, or pins. These pins are either threaded or press-fit into the bored holes. Because carbon fiber composite gets its strength from the carbon fibers running through the composite, boring a number of holes into the structure, thereby cutting the fibers, reduces the structure's strength. Boring a large number of holes and securing pins is also time-consuming and expensive. Further, after multiple heat treatment cycles, the pegs/pins still have a tendency to release from the flat plate or grid.

In contrast, metal alloy structures are often cast fixtures and can therefore include integrated pins. Using metal alloy therefore overcomes the problems of pin loss, time/cost of hole boring and loss of structural integrity with increasing number of bored holes. However, typical metal alloy structures eventually distort after being subjected to multiple heat treatment cycles. Metal alloy structures are therefore not well-suited for automated heat treatment processes.

While a design with integrated pins is easily achievable with a cast metal fixture, until now, it has not been possible to resolve this issue in an economical and reliable manner with a carbon fiber composite fixture. Accordingly, there exists a need for a new and/or improved structure for heat treating metal parts which addresses, in a cost effective manner, all or some portion of the disadvantages described above.

### SUMMARY

An interlocking grid is disclosed which, in at least some embodiments, comprises: a frame; a plurality of first members arranged approximately parallel to each other and secured to the frame, each first member comprising a body, a plurality of slots and a plurality of raised teeth; a plurality of second members arranged approximately parallel to each other and secured to the frame, each second member comprising a body, a plurality of slots and, optionally, a plurality of raised teeth, wherein the slots of the first members correspond to and interlock with the slots of the second members such that the first and second members intersect; and a plurality of securing regions, each securing region comprising a raised tooth; and wherein at least one of the plurality of first members and at least one of the plurality of second members comprises a carbon fiber composite material.

In accordance with at least some additional embodiments of the present disclosure, an interlocking grid structure is disclosed which comprises a plurality of first members arranged approximately parallel to each other and secured to the frame, the first members each comprising a body with a height of a′ and a plurality of slots projecting upward into the body for a distance of b′, each slot corresponding with a raised tooth projecting upward from the body a distance of c′, wherein the length of each raised tooth is d′; a plurality of second members arranged approximately parallel to each other and approximately perpendicular to the first members, the second members each comprising a body having a height of a and a plurality of slots extending downward to the body such that the body has a height of b at the slots, each slot bordered on either said by a raised tooth projecting upward from the body a distance of c, thereby forming a plurality of “raised tooth/slot/raised tooth” repetitions across the length of the second members, wherein the length of each “raised tooth/slot/raised tooth” repetition is d; wherein each slot of the first members corresponds to and interlocks with one slot of the second members; and a plurality of securing regions comprising the intersection of at least one raised tooth from a first member and at least one raised tooth from a second member; wherein at least one of the plurality of first members and at least one of the plurality of second members comprises a carbon fiber composite material.

In accordance with at least some additional embodiments of the present disclosure, a method of assembling an interlocking grid structure is disclosed, the method comprising: providing a plurality of first members comprising a body, a plurality of slots and a plurality of raised teeth; providing a plurality of second members comprising a body, a plurality of slots and a plurality of raised teeth; aligning the first members above the second members such that slots of the first members align with slots of the second members; and interlocking the first and second members with the corresponding slots, thereby forming a plurality of securing regions, each securing region comprising at least one raised tooth of a first member and at least one raised tooth of a second member.

In accordance with at least some additional embodiments of the present disclosure, an interlocking structure comprising: a plurality of first members; a plurality of second members arranged and interlocked with respect to the plurality of first members at a plurality of intersections, at least one of which comprises a raised securing region that is configured to support, engage and/or retain part during heat-treating of the part.

Various embodiments of the present disclosure provide a carbon fiber composite interlocking grid structure with integrated placement pins for heat treating metal parts. In other embodiments, the present disclosure provides methods for making, assembling, and/or using such an interlocking grid structure. Other features and advantages of the present disclosure will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 illustrates an exemplary interlocking structure having a plurality of interlocking first and second members which intersect to form securing regions;

FIG. 1A illustrates an interlocking structure in accordance with an exemplary alternative embodiment;

FIG. 2 is an enlarged view of a portion of FIG. 1;

FIG. 3A illustrates an exemplary second member;

FIG. 3B illustrates an exemplary first member;

FIG. 3C illustrates an enlarged view of a portion of FIG. 3A, with the portion modified to show a raised tooth having a stepped portion in accordance with an exemplary alternative embodiment;

FIG. 3D illustrates an enlarged view of a portion of FIG. 3B, with a portion modified to show a raised tooth having a stepped portion in accordance with an exemplary alternative embodiment;

FIG. 4 is an enlarged exploded view of a securing region formed by the intersection of a first member and a second member;

FIG. 5A is an enlarged exploded view of an alternative securing region formed by the intersection of a first member and a second member;

FIG. 5B shows the securing region of FIG. 5A fully assembled;

FIG. 6 illustrates an exemplary interlocking structure with a plurality of metal parts secured on securing regions;

FIG. 7 is an enlarged view of a portion of FIG. 6;

FIG. 8A illustrates a partial cross-sectional view along line 8A-8A of FIG. 7.

FIG. 8B illustrates a partial cross-sectional view, similar to that of FIG. 8A, but modified to incorporate a stepped raised securing region;

FIG. 9 illustrates exemplary stacked interlocking structures;

FIG. 10 is a perspective, partial cross-sectional, view of an interlocking structure having first and second members as shown in FIGS. 5A and 5B; and

FIG. 11 is a flowchart illustrating a method of assembling an interlocking structure in accordance with exemplary embodiments of the present disclosure.

### DETAILED DESCRIPTION

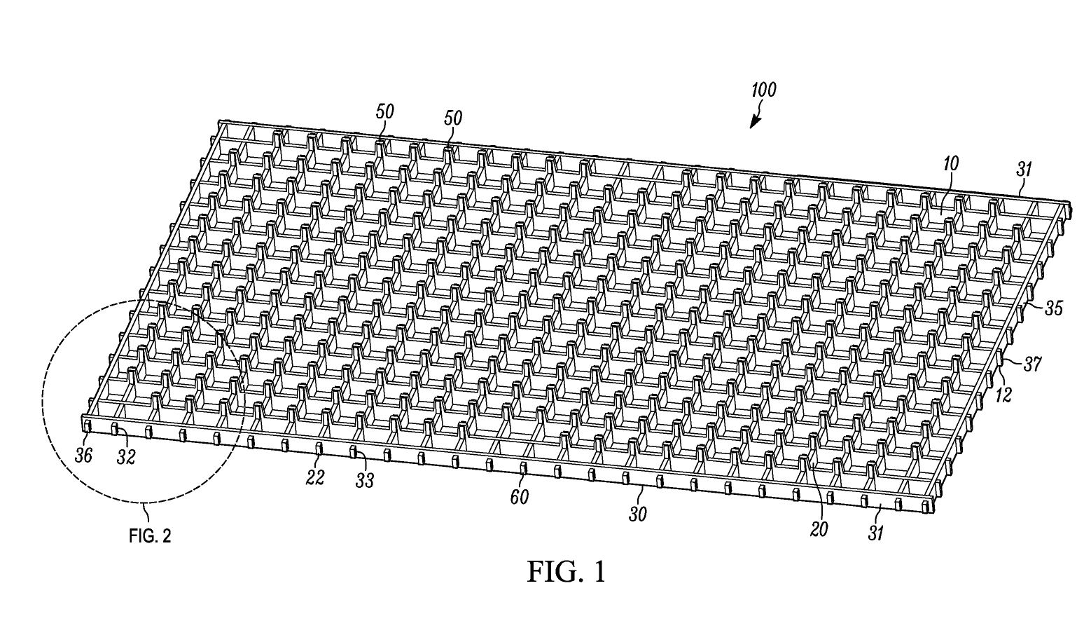

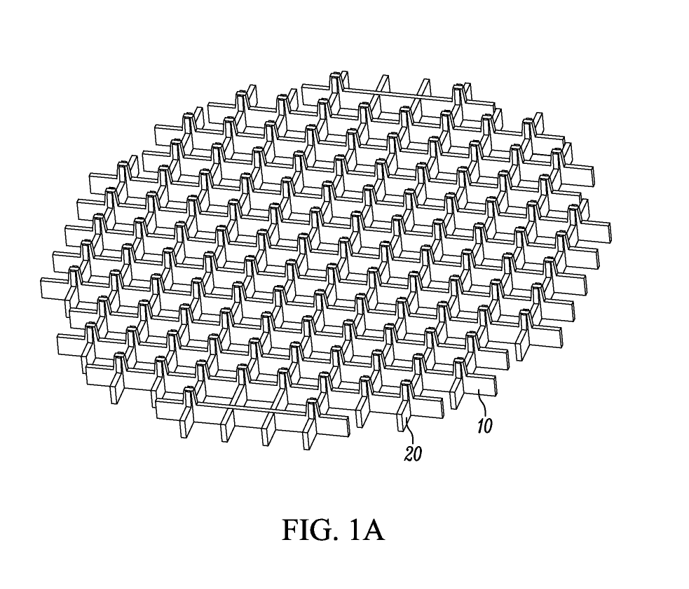

FIG. 1 illustrates an exemplary interlocking structure 100 (which can also be referred to as an “interlocking grid structure” or “fixture”) with integrated securing regions 50 for heat sealing metal parts, with FIG. 2 showing a portion of the interlocking structure 100 in further detail.

In one embodiment, the interlocking structure 100 can be used in a heat treating process. Heat treating processes include but are not limited to industrial uses such as hardening, brazing, annealing, tempering and sintering. The interlocking structure 100 can be used in a batch furnace, a continuous furnace, or an atmosphere generator.

In one embodiment, interlocking structure 100 can be used for holding parts during processing of the parts in an industrial process (with the phrase “industrial process” broadly defined herein to include any type of manufacturing or subsequent processing of parts). One such industrial process is thermally treating metal parts to obtain desired metallurgical properties. The thermal (or heat) treating process can occur onsite at a manufacturer, or the parts may be shipped to an offsite location for heat treatment. The parts to be heat treated are placed into the fixture and the loaded fixture is placed into an oven, vat, tank, etc. during the heat treating process.

In a typical heat treating process, metal is heated and cooled under tight controls to improve its properties, performance and durability. Heat treating can soften metal, to improve formability. It can make parts harder, to improve strength. It can put a hard surface on relatively soft components, to increase abrasion resistance. It can create a corrosion-resistant skin, to protect parts that would otherwise corrode. And, it can toughen or strengthen brittle products. Heat treated parts are essential to the operation of automobiles, aircraft, spacecraft, computers and heavy equipment of every kind. Saws, axes, cutting tools, bearings, gears, axles, fasteners, camshafts and crankshafts all depend on heat treating.

In the exemplary embodiment shown, interlocking structure 100 is a grid-style structure comprising a frame 30 with a plurality of first members 10, which in the exemplary embodiment shown run longitudinally (longitudinal members), and a plurality of second members 20, which in the exemplary embodiment shown run latitudinally (latitudinal members). First and second members 10, 20 intersect, resulting in the grid-like structure 100. Although first and second members 10, 20 are referred to in the following description as longitudinal and latitudinal members 10, 20, respectively, for clarity in reference to the figures, it is understood that first and second members 10, 20 may extend in any direction as permitted by frame 30, including at an angle relative to the frame 30.

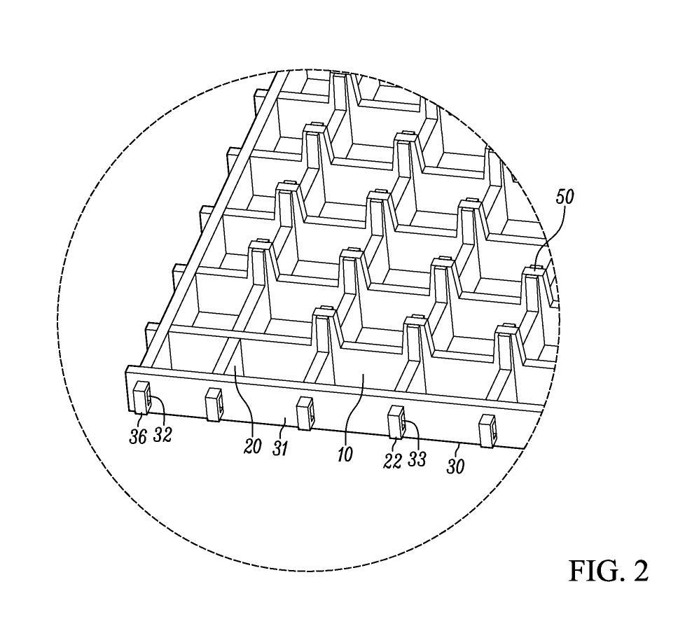

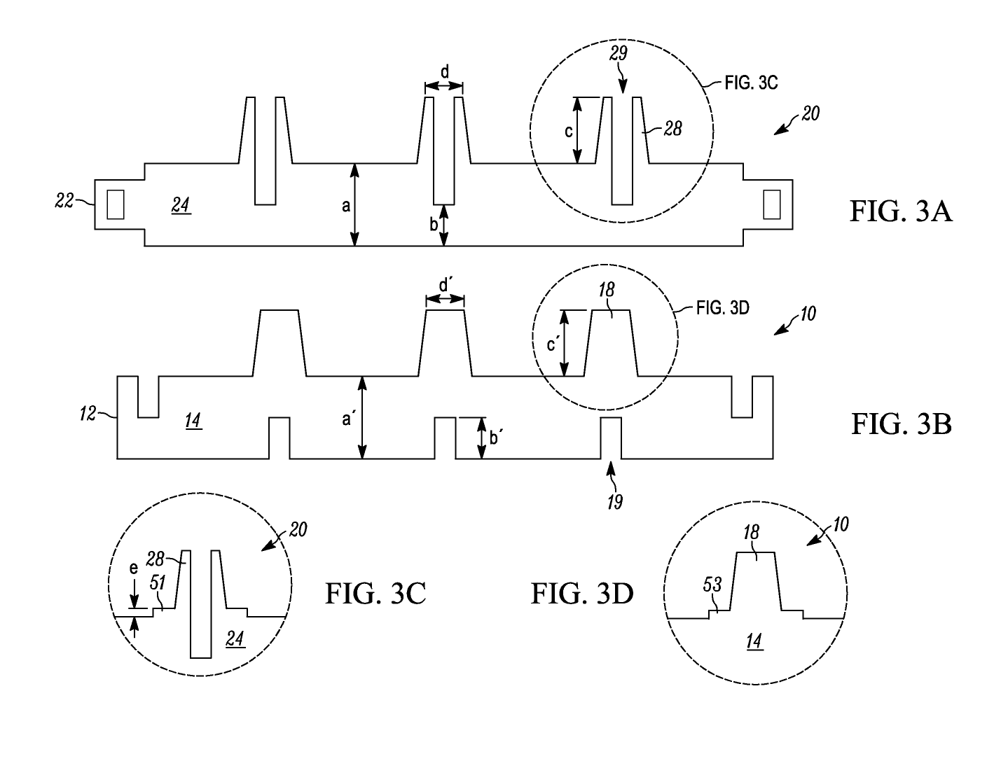

As described in more detail with reference to FIGS. 3A, 3B and 4, the longitudinal members 10 and latitudinal members 20 intersect to form securing regions 50, which in the exemplary embodiments shown are securing pin regions.

Frame 30 comprises two longitudinal sides 31, each having two frame apertures 32, located at opposite ends, for securing the latitudinal sides 35. Latitudinal sides 35 each terminate in protuberances 36 at both ends, and these protuberances 36 engage corresponding apertures 32, thereby connecting the latitudinal sides 35 and longitudinal sides 31 to form the frame 30. Frame 30 (and resulting grid structure or fixture) is shown in the figures (with the exception of FIG. 1A to be described) as rectangular, with longitudinal sides 31 substantially parallel with each other and perpendicular with latitudinal sides 35. This shape is generally constructed to be easily placed into a front loading furnace for heat treating parts. Such a furnace is typically structured or shaped generally as a cylinder on its side and with a door or receptacle located in the front.

Still, it is understood that frame 30 (and resulting grid structure or fixture) may include multiple sides and take any, or virtually any, shape in order to secure parts for heat treatment. For example, in one alternative embodiment, and as illustrated in FIG. 1A, the grid structure can be generally circular or round, and members 10 and 20 are sized and secured with respect to one another, or optionally, with respect to a frame (not shown). A round grid structure is well-suited for a bottom loading furnace, where such furnaces are typically structure or shaped as a cylinder that is upright. Since the bottom is generally round, the fixture can be generally round. Other than the shape, the interlocking grid structure 30 illustrated in FIG. 1A and related components (e.g., locking members) are the same, or essentially the same, as those of interlocking grid structure 100 of FIG. 1.

Longitudinal and latitudinal sides 31, 35 (respectively) further include a plurality of member apertures 33, 37 (respectively) disposed along the length of the sides. Member apertures 33 in longitudinal sides 31 engage corresponding terminating protuberances 22 of latitudinal members 20 to secure latitudinal members 20 to the frame 30, while member apertures 37 in latitudinal sides 35 engage corresponding terminating protuberances 12 of longitudinal members 10 to secure longitudinal members 10 to the frame 30.

Additional elements, including, but not limited to support elements 60, may also be included with interlocking structure 100. In the exemplary embodiment shown, support elements 60 help improve frame rigidity. Other embodiments may include various spacers, securing components, locking members and other structures which assist in (i) securing components on or about securing regions 50, (ii) securing sides 31, 35 of frame 30 together, and/or (iii) securing longitudinal and latitudinal members 10, 20 to each other and/or the frame 30.

In the exemplary embodiment shown in FIGS. 1 and 2, longitudinal and latitudinal members 10, 20 are evenly spaced in the frame 30, resulting in a grid-like interlocking structure 100. It is to be appreciated, however, that longitudinal and latitudinal members 10, 20 may be placed in different positions along and/or between frame sides 31, 35 depending, for example, upon the size, shape and quantity of metal parts which will ultimately be secured to interlocking grid structure 100. For example, longitudinal members 10 and/or latitudinal members 20 may be spaced closer together to accommodate a large number of smaller metal parts. In contrast, for metal parts having larger dimensions, it may be necessary to space longitudinal members 10 and/or latitudinal members 20 further apart.

One skilled in the art will readily appreciate that the location and positioning of longitudinal and latitudinal members 10, 20 will also be limited by the position of apertures 33, 37 in frame sides 31, 35. To that end, frame sides 31, 35 may include any number of apertures 33, 37 to provide multiple options for configuring longitudinal and latitudinal supports 10, 20 within the frame 30.

FIGS. 3A and 3B show an exemplary second member and 20 first member 10, respectively, disassembled from frame 30. As shown in FIG. 3A, second members 20 each comprise a body 24 and a plurality of slots 29 extending downward into member body 24. Each slot 29 is bordered on either side by a raised tooth 28. Put another way, second member 20 includes a body 24 and a plurality of raised sections, the raised sections comprising two teeth 28 separated by a slot 29, thereby forming a “raised tooth/slot/raised tooth” section which repeats along the length of member body 24. The length of the raised sections (or the length of any given raised tooth/slot/raised tooth set) is identified as d.

Second member bodies 24 have a height a between neighboring raised teeth 28 and a height of b at the slots 29, with the raised teeth 28 extending a distance of c from the top of member body 24. Second members 20 terminate in terminating protuberances 22.

Similarly, as shown in FIG. 3B, first members 10 each comprise a body 14, a plurality of raised teeth 18 extending upward from the member body 14 and a plurality of slots 19, each corresponding to raised tooth 18 and extending upward into and from the bottom of member body 14. As a result, longitudinal member bodies 14 have a height a′ between corresponding teeth 18 and slots 19. Slots 19 each have a depth into the body 14 of b′. Teeth 18 extend a distance of c′ from the top of member body 14. The length of a raised tooth 18 is d′. Longitudinal supports 10 terminate in terminating protuberances 12.

In the exemplary embodiments illustrated in FIGS. 3A and 3B, height a is approximately equal to height a′, height b is approximately equal to depth b′, distance c is approximately equal to distance c′, and length d is approximately equal to d′. As described in more detail with reference to FIG. 4, this results in an interlocking grid structure 100 having a grid-like design with a consistent base height (a, a′) and securing regions 50 of an equal height (c, c′) projecting from the interlocking grid structure 100 formed by the intersection of raised teeth 18, 28 where first and second members intersect. In accordance with at least some embodiments of the present disclosure, slot depth is maintained at half, or less than half, of the body height, that is, b′/a′ is less than 0.5 and b/a is greater than 0.5.

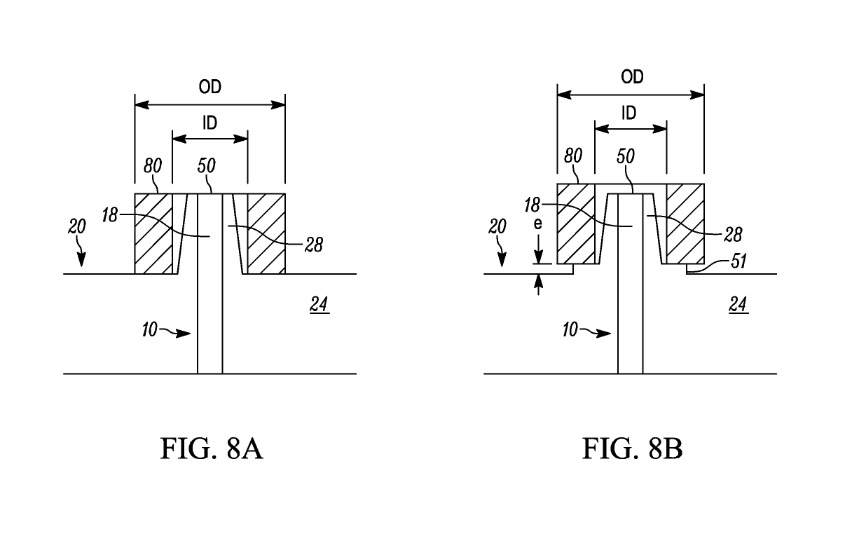

In the exemplary embodiments illustrated in FIGS. 3A and 3B, raised teeth 18, 28 are shown as trapezoidal and meet member bodies 14, 24 on either side of raised teeth 18, 28 at an angle of greater than 90 degrees, providing for integrated, raised and tapered securing regions which facilitate loading of parts onto or with respect to the interlocking grid structure. This is illustrated further with respect to FIGS. 8A and 8B. In other exemplary embodiments (although not shown), raised teeth 18, 28 may be as substantially rectangular and occurring at right angles relative to member bodies 14, 24. Other geometries, shapes and orientations of the teeth or similar raised structures are contemplated and considered within the scope of the present disclosure.

With additional reference to FIGS. 3C and 3D, enlarged views of a portion of FIG. 3A and FIG. 3B, respectively, is shown with the respective portions modified so that stepped portions 51 and 53, respectively, in accordance with exemplary alternative embodiments. As will be shown and described further with respect to FIG. 8A and FIG. 8B, the stepped portions 51 and 53 can be used, in conjunction with raised teeth 28 and 18, respectively, to facilitate positioning of a part (FIGS. 8A-8B) at a distance e above the member bodies 24 and 14, respectively of members 20 and 10, respectively.

FIG. 4 shows an exploded view of a securing region 50 formed by the intersection/joining of a first member 10 and second member 20. Slot 19 on first member 10 corresponds to slot 29 on second member 20, such that when first and second members 10, 20 are arranged approximately perpendicular to one another, first member 10 easily interlocks with second member 20 via slots 19, 29. The result is the fountain of a securing region 50 comprising a single raised tooth 18 from the first member 10 and two raised teeth 28 from the second member 20 which are perpendicular to and on either side of raised tooth 18. The width of slots 19, 29 is therefore dependent on the thickness of the members 10, 20.

With securing regions 50 formed from raised teeth 18, 28, which are an integral part of first and second members 10, 20, securing regions 50 are considered integrated with, or inseparable from, the interlocking grid structure 100. In this way, where securing regions 50 are integrated into the structure 100, the risk of losing securing regions 50 over time is greatly reduced compared to other heat treatment grids which use separately securable pins.

As shown in FIGS. 1 and 2, when viewed from the top, the raised teeth 18, 28 form securing region 50 which is a pin-like having a plus sign (+) configuration. Because the lengths d and d′ are approximately equal, as described above, each branch or leg of the securing region 50 is of equal length.

As will be described in more detail below, different shapes and configurations of raised teeth 18, 28 will result in securing regions 50 having alternative geometries, shapes and configurations. For example, in some embodiments, lengths d and d′ may not be equal, resulting in pin-like securing regions 50 having an extended dimension.

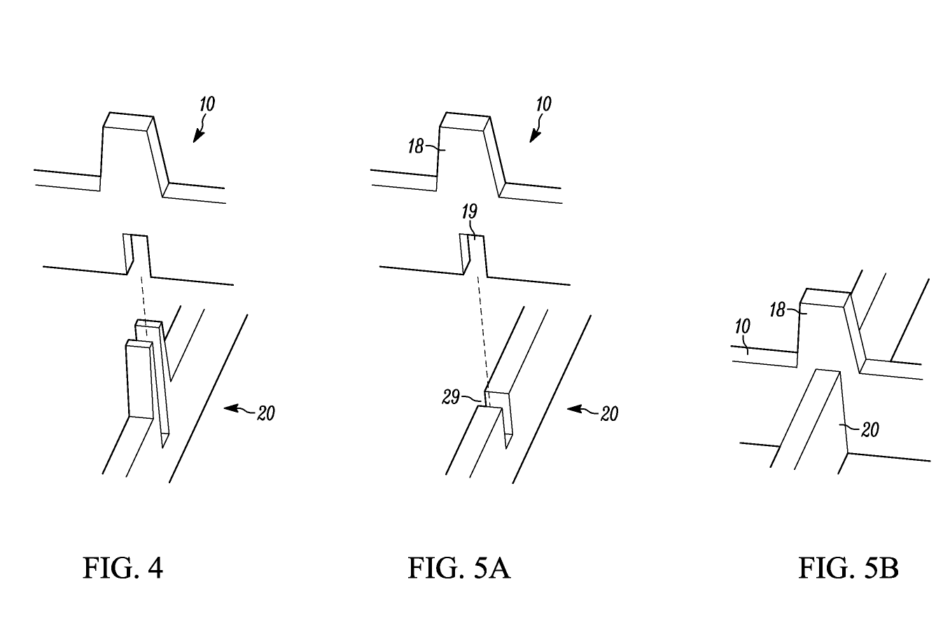

FIGS. 5A and 5B illustrate yet a further embodiment of first and second members 10, 20 resulting in securing regions 50 which have a minus sign (−) configuration. Such a design is particularly useful, for example, when securing parts having small internal voids/recesses.

In the embodiment shown in FIGS. 5A and 5B, only the first members 10 include raised teeth 18 with corresponding slots 19. As discussed in further detail below, depending on the desired diameter, or overall length, of a securing region 50, it may not be possible to leave a sufficient amount of material on a second member to form a “tooth/slot/tooth” pattern. For example, as the distance d approaches the thickness of the second member 20, the ability to form slots 29 diminishes and the amount of material remaining to form raised teeth 28 decreases. It is therefore necessary to form securing regions 50 comprising a single raised tooth 18 from first members.

In the exemplary embodiments shown in FIGS. 3A through 5B, securing regions 50 comprise the intersection of a first and second member 10, 20, wherein at least one of the first and second member includes a raised tooth at the intersection. Preferably, securing regions 50 comprise the intersection of a first and second member 10, 20, wherein the first member 10 includes a raised tooth 18 at the intersection and the second member includes raised teeth 28 at the intersection.

Most preferably, and as in the exemplary embodiments shown in reference to FIGS. 1-4, securing regions 50 comprise the intersection of one raised tooth 18 from first member 10 and two raised teeth 28 from second member 20. However, in further embodiments, additional members may intersect with first and second members 10, 20 to form securing regions 50 comprising the intersection of more than three raised teeth. In an embodiment, securing regions 50 comprise the intersection of a plurality of raised teeth, and preferably comprise the intersection of one raised tooth 18 and two raised teeth 28.

In a further embodiment, securing regions 50 consist solely of the intersection of a first member and a second member 10, 20. In an embodiment, securing regions 50 consist solely of the intersection of a first member and a second member 10, 20, wherein the first member includes a raised tooth at the intersection. In yet a further embodiment, securing regions 50 consist solely of the intersection of a first and second member 10, 20, and preferably wherein the first member 10 includes a raised tooth 18 at the intersection and the second member includes two raised teeth 28 at the intersection.

In an embodiment, securing regions 50 are each made only from raised teeth on first and second members 10, 20 (and any additional member, if present), and are inseparable from structure 100.

Because first and second members 10, 20 are press fit together, or interlocked with each other using only corresponding slots 19, 29, it is important that the slot thickness be as close to the thickness of the member bodies 14, 24 as possible. First and second members 10, 20 are held together by friction.

In an embodiment, slots 19, 29 have a width within 1/10^{th} to 1/1000^{th} of an inch of the thickness of member bodies 14, 24. In further embodiments, slots 19, 29 have a width within 1/100^{th} to 1/1000ths of an inch, and preferably within 1/1000ths of an inch, of the thickness of member bodies 14, 24.

In a preferred embodiment, the thickness of member bodies 14, 24 is greater than the width of slots 19, 29. Preferably, the thickness of member bodies 14, 24 is approximately 1/10^{th} to 1/1000^{th} of an inch greater than the width of slots 19, 29. More preferably, the thickness of member bodies 14, 24 is approximately 1/100^{th} to 1/1000^{th} of an inch, and most preferably approximately 1/1000^{th} of an inch, greater than the width of slots 19, 29.

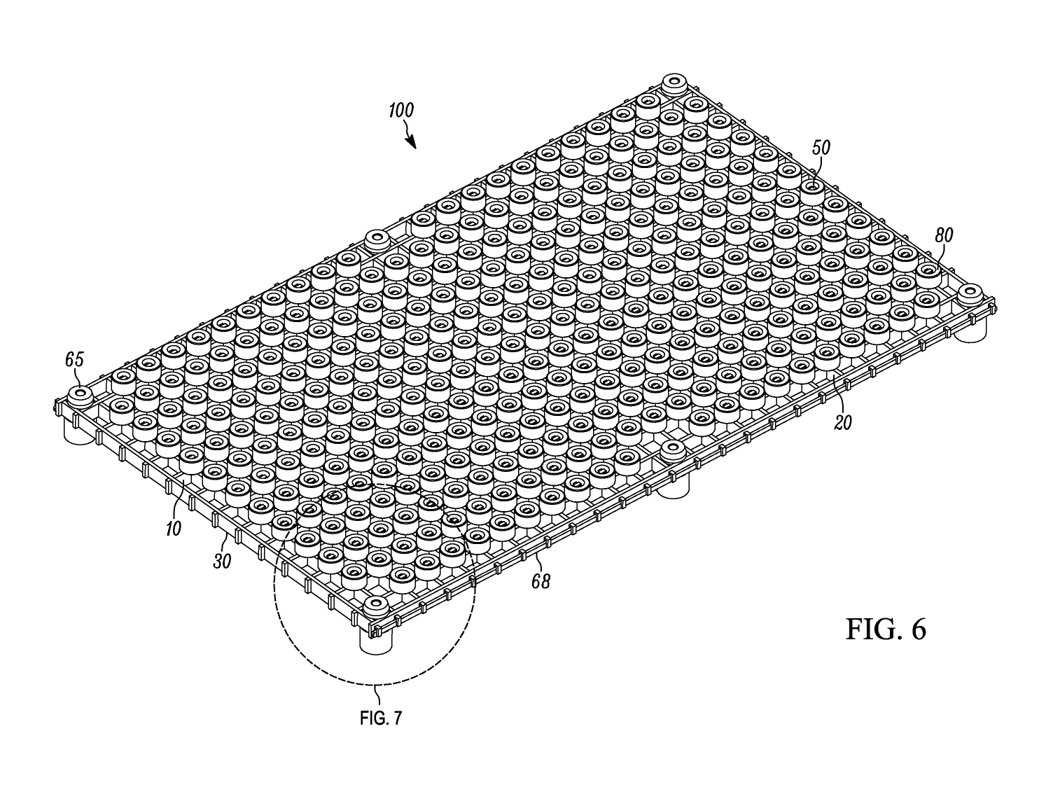

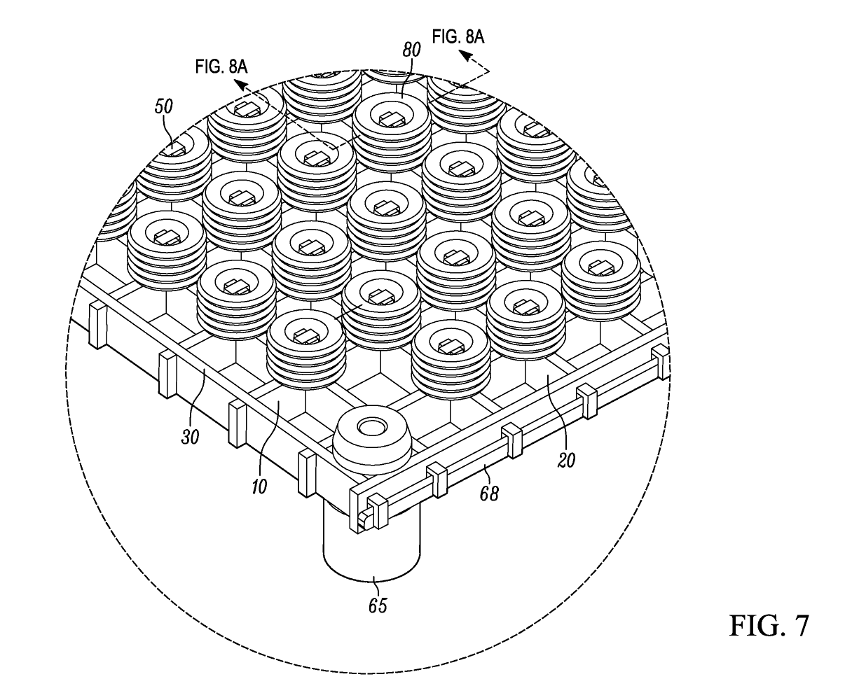

FIG. 6 illustrates an exemplary interlocking structure 100 according to FIGS. 1-4, as described above, with a plurality of parts 80, which in the embodiment shown are metal parts, secured to securing regions 50. It will be understood that an interlocking structure 100 according to the embodiments of FIGS. 5A and 5B may include the same additional components and will secure parts in the same manner as described in relation to FIGS. 6 and 7, below, with the difference being only the specific geometry of the securing regions 50.

FIG. 7 shows a portion of FIG. 6 in further detail. In the exemplary embodiment shown, metal parts 80 each have an inner diameter approximately equal to, or just greater than, lengths d and d′. As a result, when metal parts 80 are placed on securing regions 50, metal parts are secured in place with little or no side-to-side or rotational movement relative to securing regions 50.

FIG. 8A illustrates a partial cross-sectional view of FIG. 7 and FIG. 8B illustrates a partial cross-sectional view, similar to that of FIG. 8A. As illustrated, part 80 (e.g., a gear) is shown engaged with respect to raised securing region 50 that, in the embodiment shown, comprises raises sections 18 and 28 of members 10 and 20, respectively. Part 50, in the embodiment illustrated, is a structure or component that includes an internal void having an inner diameter ID and an outer diameter OD. In the present embodiment, the raised securing region is tapered outwardly so that it is wider near the member body 24 (and, although not visible, also wider near the member body of member 10) than at its opposite end (e.g., at its top or upper surface), and still just smaller than the ID so that the part fits securely with respect to the raised securing member and on the member body 24 (and member body of member 10).

In FIG. 8B, the structure is modified to include stepped raised securing region 33 which is formed in member, allowing the part 80 to sit above or otherwise be spaced apart, as shown at a distance e, from member body 24. It is understood that, while not visible, the member 10 can include raised stepped region(s) providing for additional support to the part 80 at a distance above the member body of member 10. Again, in the present embodiment, the raised securing region 50 is tapered outwardly so that it is wider, in this case near the stepped region 51, but still just smaller than the ID of the part 80 so that the part fits securely with respect to the raised securing member and on the stepped region 51. It is understood that the one or more stepped regions may be used to support a part, such as part 80 and that the stepped region(s), as well as the securing region(s), can vary in shape to accommodate placement and positioning of a given type of part, such as to accommodate a given shape and/or dimension of an internal void(s) of the part. In accordance with at least some alternative embodiments, one or more stepped region(s) can be provided by virtue of a discrete and distinct (e.g., separate) structural component that is positioned in relation to (e.g., around) the raised securing region(s) of the first and/or second member(s).

FIGS. 6 and 7 illustrate an exemplary locking member 68 for use with frame 30 to secure first and/or second members 10, 20 to frame 30. Locking member 68 engage the terminal protuberances 12, 22 of members 10 and/or 20 (in this case, terminal protuberances 22 of second members 20) to prevent members 10, 20 from disengaging frame 30. In the exemplary embodiment shown in FIG. 6, terminal protuberances 22 of second members 20 each include a securing aperture through which locking member 68 extends. In other exemplary embodiments, locking member 68 may engage terminal protuberances 12, 22 of members 10, 20 using other or intermediate structures or means.

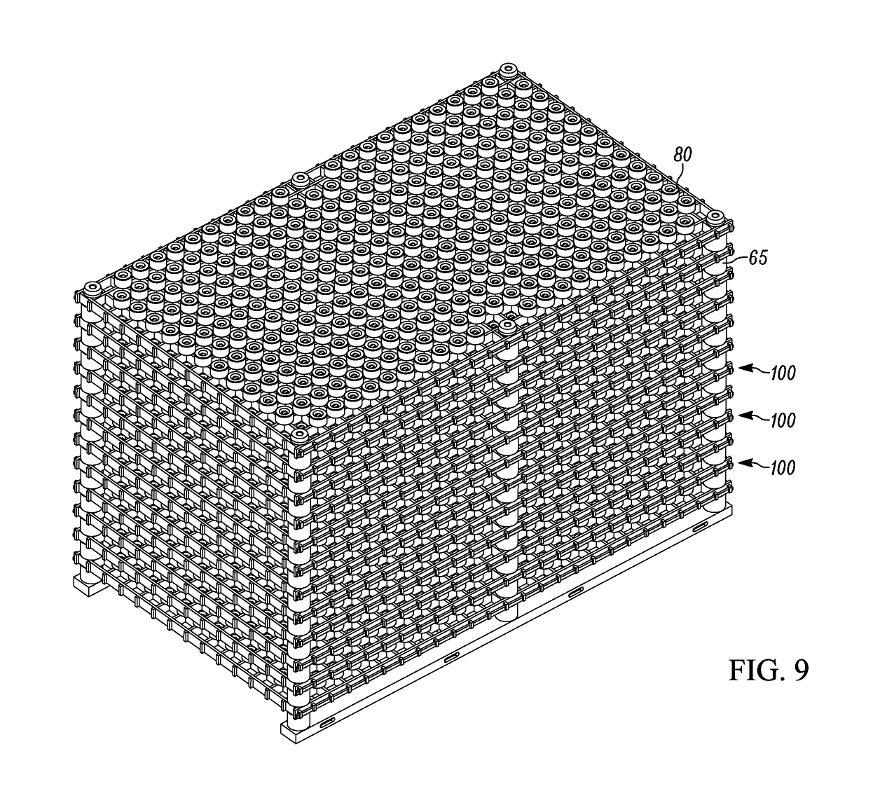

Also shown in FIGS. 6 and 7 are spacer components 65. Spacer components 65 are disposed about the perimeter of interlocking grid structure 100. In the exemplary embodiment shown, spacer components 65 extend through interlocking grid structure 100 and project a distance above members 10, 20 (i.e., have a height greater than a and a′) and also protrude a distance below frame 30. With reference to FIG. 9, spacer components 65 are used to secure multiple stacked interlocking grid structures 100 at a given distance from each other to prevent metal parts 80 from contacting the above interlocking grid structure 100.

Although spacer components 65 are illustrated as cylindrical, peg-like structures, any structure or configuration of structures may be used to support interlocking grid structures 100 at a distance from each other so long as metal parts 80 are prevent from physically contacting any other surface. For example, depending on the size of the metal parts 80, spacer components 65 may need to be larger to provide a greater distance between interlocking sheets 100. In other embodiments, spacer components 65 may be smaller to fit more interlocking sheets 100 in a given volume. In other embodiments, spacer components 65 may be a single structure or formed from multiple substructures.

Similarly, while the present embodiment is shown using six spacer components 65, it is understood that more or fewer spacer components 65 may be used depending on, for example, the size, shape and/or weight of interlocking structure 100 and/or metal components 80. Further, additional spacer components 65 may be located inward from the perimeter of the frame 30.

In an embodiment, spacer components 65 are specifically configured to hold stacked interlocking structures 100 apart such that the distance from the top of the securing regions of a first interlocking grid structure 100 to the bottom of the interlocking structure 100 directly above the first interlocking structure 100 is less that the overall height of parts 80. This configuration ensures that parts 80 do not disengage securing regions 50 when interlocking grid structures 100 are stacked.

In the exemplary embodiments shown and described above, metal parts 80 are illustrated as cylindrical transmission gears (which are illustrated in greatest detail in FIG. 7). However, any metal parts which require heat treating and have an internal void or aperture which can engage a pin-like structure may be secured to the interlocking structure 100. For example, the present interlocking structure 100 may be used by manufacturers of metal parts which require heat treating, such as for automotive, aerospace, or other industrial uses, or by companies who provide heat treating services to the manufacturers of metal parts or assemblies.

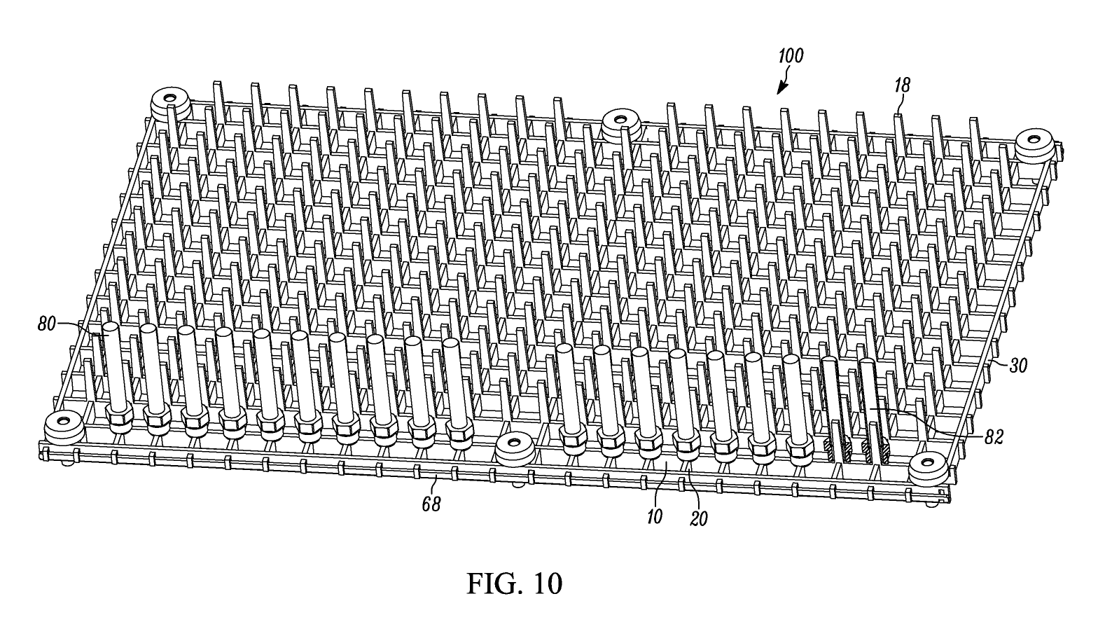

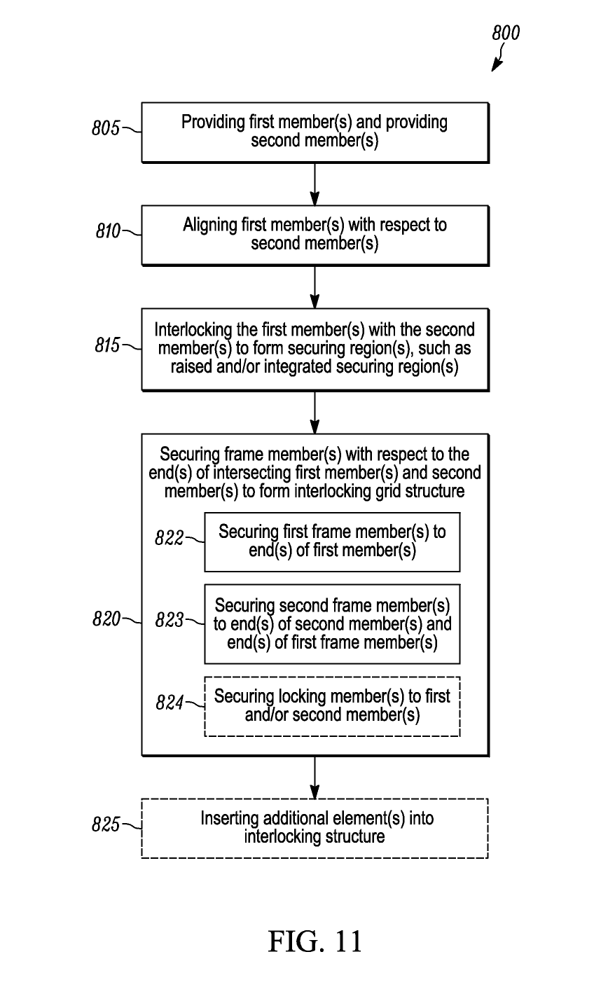

FIG. 10 is a perspective, partial cross-sectional, view of an interlocking structure 100 having first and second members 10, 20 as described with reference to FIGS. 5A and 5B, above. In the embodiment shown, securing regions 50 comprise the intersection of a first and second member 10, 20, wherein only the first member 10 includes a raised tooth 18. Part 80, which in the embodiment shown are metal parts, contain an internal void 82. The securing regions 50 engage the internal void 82 to secure parts 80 to securing regions 50.

In the embodiment shown in FIG. 10, first members 10, containing raised teeth 18, extend latitudinally, while second members 20, containing slots 29 (not visible) and no raised teeth, extend longitudinally. Locking member 68 secures second members 20 in frame 30.

Also shown in FIG. 10 is an alternative geometry for raised teeth 18. As illustrated, raised teeth 18 are pyramidal, such that the lower base of raised teeth 18 is longer than the upper surface and the sides of the raised teeth 18 meet with member body 14 at an angle of greater than 90 degrees. As a result, securing regions 50 are tapered. While such an embodiment may be used to secure parts 80 having an internal void 82 of a consistent dimension (e.g., consistent internal diameter), as shown, the tapered securing region 50 may also be used to secure parts 80 having a matching internal void.

In some embodiments, including embodiments wherein both first and second members 10, 20 include raised teeth, raised teeth may be shaped to form multiple alternative geometries for securing regions 50. For example, securing regions 50 may be stepped, tapered, widen, become circular, or otherwise change shape over the distance c and/or c′.

In the exemplary embodiments disclosed herein, members 10, 20, and therefore securing regions, are made from carbon fiber composite. Carbon fiber composite inherently poses several difficulties when making structures for securing components during heat treatment processes that needed to be overcome. For example, the interlocking structures 100 disclosed herein are grid-like structures with members 10, 20 interlocking with each other at approximately right angles. Alternative grid geometries, such as a hex pattern, are known to be more efficient for arranging large numbers of pieces; however, the nature of carbon fiber composite renders such alternative grid geometries inoperable.

In another embodiment, carbon fiber composite is carbon fiber reinforced carbon. In another embodiment, the carbon fiber composite contains a network of carbon fibers in a matrix, whereby the matrix is formed of heat resistance materials, including but not limited to SiC, Al₂O₃, one or more refractory fibers or a mixture thereof.

In one embodiment, the carbon fiber composite comprises natural glass, aramide, polymer, carbon and/or ceramic fibers. In another embodiment, the carbon fiber composite comprises polymer fibers that form the matrices, including but not limited to PEEK fibers, PPS fibers, PA fibers, PE fibers or PP fibers.

In still another embodiment, carbon fiber composite contains a network of carbon fibers in a matrix resin, such as a polymer resin. In one embodiment, the carbon-containing fiber is a carbon fiber formed from filaments that substantially comprise carbon atoms. In at least one embodiment, the carbon fibers may have a turbostratic or graphitic structure. In other embodiments, the carbon may have an amorphous structure. The carbon fibers may be single crystalline or polycrystalline, depending on the application.

In one embodiment, the fibers are part of a woven (fabric) sheet. In another embodiment the fibers are part of a mat or bundle. The woven fabric sheet, mat and bundles may contain pores. The pores may refer to empty spaces within the confines of the structure that are not filled by the individual fibers.

In some embodiments, the fibers are individual strands. These strands may have diameters of at least about 1 nm including but not limited to at least about 5 nm, about 10 nm, about 50 nm, about 100 nm, about 500 nm, about 1 micron, about 5 microns, about 10 microns, about 50 microns, about 100 microns, about 500 microns, about 1 mm, or more. In at least one embodiment, the strands have a diameter in the range of from about 1 nm to about 1 mm including but not limited to from about 5 nm to about 500 microns, from about 10 nm to about 100 microns, from about 50 nm to about 100 microns, from about 100 nm to about 50 microns, from about 500 nm to about 10 microns, from about 1 micron to about 5 microns, or from about 5 to about 10 microns. The length of the strands is not limited and may be in the millimeter range, centimeter range or even meter range.

In one embodiment, the fiber may comprise a glass fiber that comprises an oxide glass, silicate glass, borosilicate glass, phosphate glass, phosphosilicate glass, aluminophosphate glass, borophosphate glass, aluminosilicate glass, aluminoborosilicate glass, alkali-lime glass, alumino-lime silicate glass, or any combinations thereof.

In another embodiment, the fiber may comprise a silicon carbide fiber. In at least one embodiment, the fiber may be a boron fiber. Other types of materials are also possible.

In yet another embodiment, the fiber or fibers may be a part of a composite material that includes carbon fibers in a matrix, whereby the matrix is formed of heat resistant materials, like carbon, SiC, Al2O3, one or more refractory fibers, or a mixture thereof.

Carbon fibers typically run in at least two directions (usually perpendicular to each other) through a matrix resin. The strength of the composite comes from the number and length of carbon fibers running in a given direction through the matrix. For example, with reference to FIGS. 3A and 3B, the length of member bodies 14, 24 (shown as corresponding to the x direction) makes the longest direction fibers may run. When cutting members 10, 20 from carbon fiber, it is desirable to cut members 10, 20 such that carbon fibers are oriented in the x direction. Therefore, cuts in the y direction, which reduce the length of fibers, and cuts in the z direction, which reduce the number of fibers, will decrease the overall strength of members 10, 20. Similarly, and again with reference to FIGS. 3A and 3B, assuming the second set of carbon fibers present in the composite runs in they direction, the strength of members 10, 20 is decreased as the number and length of fibers in the y direction decreases. Therefore, cuts in the x and z directions will reduce member 10, 20 strength.

In one embodiment, carbon fiber composite is densified, which is measured and reflected in the density and porosity. In one embodiment, the carbon fiber composite is fully densified, wherein the open porosity is less than 10%.

In yet another embodiment, members 10, 20, and therefore securing regions, are made from carbon fiber composite having a porosity selected from the group consisting of a porosity of less than about 12%, a porosity of less than about 11%, a porosity of less than about 10%, a porosity of less than about 9%, a porosity of less than about 8%, a porosity of less than about 7%, and a porosity of less than about 6%.

In still another embodiment, members 10, 20, and therefore securing regions, are made from carbon fiber composite having a porosity selected from the group consisting of from about 6% to about 12%, from about 6% to about 10%, and from about 6% to about 8%.

In another embodiment, members 10, 20, and therefore securing regions, are made from carbon fiber composite having a porosity selected from the group consisting of from about 8% to about 12% and from about 8% to about 10%.

In another embodiment, members 10, 20, and therefore securing regions, are made from carbon fiber composite having a porosity from about 10% to about 12%.

In one embodiment, carbon fiber composites can be made out of refractory fibers including but not limited to carbon fibers, silicon carbide (SiC) fibers, aluminum oxide (Al₂O₃) fibers, carbon black, pitch (natural and/or synthetic), Cr₂O₃, ZrO₂, TiO₂, Si₃N₄, B₄C, TiC, (CaO)₆Al₂O₃, Si₂ON₂ (silicon oxynitride), Sialon (ceramic alloys based on silicon, aluminum, oxygen and nitrogen), aluminum metal powder, copper metal flake, or silicon metal powder, or a mixture of two or more thereof. In another embodiment, carbon fiber composites can comprise a matrix system, which holds the fibers and transfers the load into the fibers, making it a composite, whereby the matrix is formed of heat resistance materials, like carbon, SiC, Al₂O₃ and other materials recited above.

In another embodiment, the one or more refractory fibers comprise from about 1 to about 40 weight percent SiC, and from about 1 to about 10 weight percent carbon black, pitch, Al₂O₃, Cr₂O₃, ZrO₂, SiO₂, TiO₂, Si₃N₄, (CaO)₆Al₂O₃, B₄C, TiC, Si₂ON₂, Sialon, aluminum metal powder or silicon metal powder, or a mixture of two or more thereof, based on the weight of the monolithic refractory castable material (prior to mixing with water).

In another embodiment, members 10, 20, and therefore securing regions can be coated to prevent reaction with other metal parts. In one embodiment, the coatings can be ceramic coatings. In still another embodiment, ceramic coatings can be made from refractory ceramics including but not limited to SiC, Al₂O₃, zirconia oxide, Yttria-stabilized zirconia (YSZ), chromium oxide, tungsten carbide, aluminum, tin, zinc, nickel chromium, mullites, and combinations thereof.

In one embodiment, carbon fiber composite can be obtained from one or more commercial sources including but not limited to: carbon fiber, both high and low modulus, such as those available from Toray, Hexcel, Cytec, Tenax Toho, and Mitsubushi; E, R, and S-glass fibers; Cem-FIL® glass fiber available from Owens Corning; silica-based continuous glass fiber; alumino and alumiosilicate-based continuous fibers, such as Nextel® fibers available from 3M, Almax® fibers available from Mitsui Mining, and basalt-based fibers such as those available from Basaltex and Sudaglass; and SiC-based continuous fibers (e.g., Nicalon® fiber available from Nippon Carbon).

In yet another embodiment, carbon fiber composites can be obtained from Schunk Kohlenstofftechnik GmbH. In one embodiment, the carbon fiber composite is one or more of CF 222/2, CF 225/2, CF 226/2, CF 227/2, CF 260, CF 280, CF 222, CF 225, CF 226, and CF 227, which are available from Schunk Kohlenstofftechnik GmbH.

In one embodiment, the carbon fiber composite is CF 226. Table 1 provides a summary of the characteristics and properties of CF 226.

TABLE 1
Grade CF 226

Reinforcement: cloth

| | | |
|---|---|---|
| Fiber volume fraction | (% by volume) | 60 |
| Bulk density | (g/cm³) | 1.50 |
| Porosity | (%) | 8 |
| Flexural strength | (MPa) | 120 |
| Strain to failure | (%) | 0.23 |
| Young's modulus (dyn.) | (GPa) | 60 |
| Fracture behaviour | | pseudoplastic |
| Interlaminar shear strength | (MPa) | 8 |
| Final heat treatment temperature | (° C./° F.) | 2000° C./3630° F. |
| Coefficient of thermal expansion | (10⁻⁶/K) | |
| α 25-670° C. (α 75-1235 ° F.) | | |
| \|\| to the plane of reinforcement | | 0.8 |
| ⊥ to the plane of reinforcement | | 7.3 |
| Specific electrical resistance | (μΩm) | 25 |
| at ambient temperature | | |
| Thermal conductivity | (W/mK) | |
| \|\| to the plane of reinforcement | | 40 |
| ⊥ to the plane of reinforcement | | 5 |
| Ash | (ppm) | >300 |

In one embodiment, the carbon fiber composite is CF 227. Table 2 provides a summary of the characteristics and properties of CF 227.

TABLE 2
Grade CF 227

| | | |
|---|---|---|
| Bulk density | (g/cm³) | 1.55 |
| Porosity | (%) | 8 |
| Flexural strength | (MPa) | 170 |
| Tensile strength | (MPa) | 250 |
| Strain to failure (tension) | (%) | 0.25 |
| Strain to failure (flexion) | (%) | 0.3 |
| Young's modulus | (GPa) | |
| Tension | | 90 |
| flexion | | 75 |
| Interlaminar shear strength | (MPa) | 9 |
| Coefficient of thermal expansion | (10⁻⁶/K) | 1.1 |
| α 1000° C. (1830° F.) | | |
| Specific electrical resistance | (μΩm) | 22 |
| Ash | (ppm) | >300 |

In yet another embodiment, members 10 and 20, and therefore securing regions, can comprise fiber reinforced plastic material. Members 10 and 20 comprising fiber-reinforced plastic can furthermore be at least carbonized but also carbonized and graphitized, making components of fiber reinforced carbon or graphite available. As preferred reinforcing fibers, ceramic fibers such as SiC fibers or carbon fibers can be used.

In still another embodiment, both fiber-reinforced plastic components and fiber reinforced carbon components, which are distinguished in particular by their high-temperature resistance, can be used in embodiments of the interlocking structure, such as interlocking structure 100.

With the above consideration in mind, it is understood that cutting certain patterns, such as that necessary to form a hexagonal-type grid, would cut across more fibers than the embodiment shown in FIGS. 1-8 and therefore result in a weaker structure. While one skilled in the art will readily understand that the orientation of carbon fibers in a member 10, 20 is not necessary a direct prohibition of certain member geometries/shapes, the nature of carbon fiber does require additional consideration when cutting first and second members 10, 20 to make securing regions 50 of different geometries.

The same principles apply for the specific geometry of securing regions 50. If too much carbon fiber composite is cut away at a given spot in a carbon fiber composite plate, that section of the plate becomes weakened. It is therefore necessary to ensure a minimum necessary amount of material remains around the cuts forming the securing regions (i.e., raised teeth 18, 28 and slots 19, 29).

For example, in some embodiments, and particularly when used for securing components 80 having small internal voids/recesses, it may not be possible to form a securing region 50 having a small enough diameter or overall length when using the raised teeth 18, 28 and slot 19, 29 geometry described, above. In circumstances having are reduced sizing, space, dimensions or other similar limited characteristics, securing regions 50 can comprise only a single raised tooth, such as shown in FIGS. 5A and 5B.

Similarly, given the nature of carbon fiber composite, securing regions with a diameter or overall length of approximately 0.2500 inches or less are typically too fragile to secure components 80. Therefore, in an embodiment, at least one of d and d′, and preferably both d and d′, is greater than or equal to 0.2500 inches, or greater than or equal to 0.3000 inches, or greater than or equal to 0.500 inches.

Although the exemplary interlocking structures described above are illustrated with first members 10 having upward projecting slots 19, such that first members 10 are configured to slide onto second member 20 from above at corresponding downward projecting slot 29, it should be understood that first and second members 10, 20 may have the opposite configuration in other embodiments. It will be readily appreciated that the relative dimensions described with reference to FIGS. 3A, 3B, 3C, 3D and 4 generally apply to their respective portions (i.e., teeth, recesses, body) even when such portions are located on an opposite member.

In an embodiment, the present invention includes a process of manufacturing an interlocking grid structure as described herein. FIG. 10 is a flowchart 800 showing exemplary steps for manufacturing an interlocking structure 100 as described herein.

The process of manufacturing an interlocking grid structure comprises a first step 805 of providing at least one, preferably two, and most preferably a plurality of first members and providing at least one, preferably two, and most preferably a plurality of second members. In one embodiment, the first and second members are machined from carbon fiber composite. In a preferred embodiment, the first and second members are machined having raised teeth and slots as described herein with reference to FIGS. 3A, 3B, 4, 5A and/or 5B.

In step 810, the first members are aligned above the second members, such that the slots of the first members each correspond with a slot of the second members. In one embodiment, first members are aligned above and substantially perpendicular to, or perpendicular to, second members. However, in other embodiments, it will be appreciated that the angle at which the slots and raised teeth were machined may allow for alternative positioning of first members relative to second members. For example, in one embodiment, based on the machining of the respective recesses, first members may be positioned at an angle of less than 90° relative to a first end of second members. In other embodiments, based on the machining of the respective recesses, first members may be positioned at an angle of more than 90° relative to a first end of the second members.

In step 815, the first members are interlocked with the second members by engaging corresponding slots, thereby forming a plurality of securing regions comprising the intersection of raised teeth. Thus, in accordance with at least some embodiments, the securing regions (e.g., securing regions 50) can also be referred to as raised and/or integrated securing regions.

To provide added stability and secure the first and second members in position, frame members are secured to the ends of the members in step 820. In one embodiment, step 820 includes the substeps of 822 securing first frame members to the ends of the first members and 823 securing a frame member to the ends of the second members and ends of the first frame members. The step 820 of securing frame members to the ends of first and second members may also include the substep 824 of securing at least one locking member to the ends of at least a portion of the first and/or second members, such as by sliding the locking member through apertures disposed on the ends of the first and/or second members.

Optionally, in step 825, additional components, such as support elements or spacers are inserted into the interlocking grid structure.

Also, notwithstanding the usage above of terms such as “upper”, “lower”, “top”, “bottom”, and “side” and other terms or references to describe relative positioning or movement of various elements of the grid structure relative to one another and/or another reference point, it should be understood that the present disclosure is intended to encompass a variety of other embodiments having features that do not satisfy one or more the above relational characteristics described above.

Nonlimiting examples of the present invention are provided below.

E1. An interlocking grid comprising: a frame; a plurality of first members arranged approximately parallel to each other and secured to the frame, each first member comprising a body, a plurality of slots and a plurality of raised teeth; a plurality of second members arranged approximately parallel to each other and secured to the frame, each second member comprising a body, a plurality of slots and, optionally, a plurality of raised teeth, wherein the slots of the first members correspond to and interlock with the slots of the second members such that the first and second members intersect; and a plurality of securing regions, each securing region comprising a raised tooth; wherein at least one of the plurality of first members and at least one of the plurality of second members comprises a carbon fiber composite material.

E2. The interlocking grid of E1, wherein the second members each include a plurality of raised teeth.

E3. The interlocking grid of E1, wherein each securing region comprises the intersection of at least one raised tooth from a first member and at least one raised tooth from a second member

E4. The interlocking grid of E3, wherein the slots of the first members project upward into the body and the teeth of the first members project upward from the body above the recesses.

E5. The interlocking grid of E4, wherein the slots of the second members project downward into the body and each slot is bordered by two raised teeth projecting upward from the body immediately adjacent the corresponding recess, thereby forming repetitions of “tooth-slot-tooth” along the body.

E6. The interlocking grid of claim E5, wherein the second members have a body height between “tooth-slot-tooth” repetitions of a, a body height at slots of b, each raised tooth has a height of c from the upper surface of the body, and each “tooth-slot-tooth” repetition has a length of d.

E7. The interlocking grid structure of E 6, wherein the first members have a body height between raised teeth of a′, each slot projects into the body of the longitudinal member for a distance of b′, each raised tooth has a height of c′ from the upper surface of the body, and each raised tooth has a length of d′.

E8. The interlocking grid structure of E7, wherein a=a′, b=b′, c=c′ and d=d′.

E9. The interlocking grid structure of E1, wherein each of the first and second members terminates at both ends with a protuberance.

E10. The interlocking grid structure of E9, wherein the frame includes a plurality of apertures configured to receive the terminal protuberances of the first and second members.

E11. The interlocking grid structure of E1, further comprising at least one spacer.

E12. An interlocking grid structure comprising: a plurality of first members arranged approximately parallel to each other and secured to the frame, the first members each comprising a body with a height of a′ and a plurality of slots projecting upward into the body for a distance of b′, each slot corresponding with a raised tooth projecting upward from the body a distance of c′, wherein the length of each raised tooth is d′; a plurality of second members arranged approximately parallel to each other and approximately perpendicular to the first members, the second members each comprising a body having a height of a and a plurality of slots extending downward to the body such that the body has a height of b at the slots, each slot bordered on either said by a raised tooth projecting upward from the body a distance of c, thereby forming a plurality of “raised tooth/slot/raised tooth” repetitions across the length of the second members, wherein the length of each “raised tooth/slot/raised tooth” repetition is d; wherein each slot of the first members corresponds to and interlocks with one slot of the second members; and a plurality of securing regions comprising the intersection of at least one raised tooth from a first member and at least one raised tooth from a second member; wherein at least one of the plurality of first members and at least one of the plurality of second members comprises a carbon fiber composite material.

E13. The interlocking grid structure of E12, wherein the securing regions are pins.

E14. The interlocking grid structure of claim E12, wherein the frame is either rectangular or circular.

E15. A method of assembling an interlocking grid structure comprising: providing a plurality of first members comprising a body, a plurality of slots and a plurality of raised teeth; providing a plurality of second members comprising a body, a plurality of slots and a plurality of raised teeth; aligning the first members above the second members such that slots of the first members align with slots of the second members; and interlocking the first and second members with the corresponding slots, thereby forming a plurality of securing regions, each securing region comprising at least one raised tooth of a first member and at least one raised tooth of a second member.

E16. The method of claim E15, wherein the aligning includes aligning the first members so as to be substantially perpendicular with the second members.

E17. The method of claim E15, wherein the providing of the plurality of first members includes providing at least one of the plurality of first members to have a carbon fiber material and wherein the providing of the plurality of second members includes providing at least one of the plurality of second members to have a carbon fiber composite material.

E18. An interlocking structure comprising: a plurality of first members; a plurality of second members arranged and interlocked with respect to the plurality of first members at a plurality of intersections, at least one of which comprises a raised securing region that is configured to support, engage and/or retain a part during heat-treating of the part.

E19. The interlocking structure of E18 wherein each of the plurality of first members and each of the plurality of second members comprises a carbon fiber composite material.

E20. The interlocking structure of E19, wherein the plurality of first members are approximately parallel to each other and optionally secured to a frame, each first member comprising a body, a plurality of slots and a plurality of raised teeth and wherein the plurality of second members are arranged approximately parallel to each other and optionally secured to the frame, each second member comprising a body, a plurality of slots and, optionally, a plurality of raised teeth, wherein the slots of the first members correspond to and interlock with the slots of the second members and such that a plurality of raised securing regions are provided, each comprising a raised tooth.

E21. The interlocking structure of E18, wherein one or both of: (i) at least one of the plurality of first members includes a stepped region that, in conjunction with the raised tooth, is used to support the part during the heat-treating; and (ii) at least one of the plurality of second members includes a stepped region that, in conjunction with the raised tooth, is used to support the part during heat-treating.

E22. The interlocking structure of E18, wherein the part is a metal part and the heat-treating is selected from one of the following processes: hardening, brazing, annealing, tempering and sintering.

E23. The interlocking structure of E22 wherein the plurality of first members and the plurality of second members comprises a carbon fiber composite material.

It shall be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

We claim:

1. An interlocking grid comprising:
a frame;
a plurality of first members arranged approximately parallel to each other and secured to the frame, each first member comprising a body, a plurality of slots and a plurality of raised teeth;
a plurality of second members arranged approximately parallel to each other and secured to the frame, each second member comprising a body, a plurality of slots and, optionally, a plurality of raised teeth, wherein the slots of the first members correspond to and interlock with the slots of the second members such that the first and second members intersect; and
a plurality of securing regions, each securing region comprising a raised tooth;
wherein at least one of the plurality of first members and at least one of the plurality of second members comprises a carbon fiber composite material.

2. The interlocking grid of claim 1, wherein the second members each include a plurality of raised teeth.

3. The interlocking grid of claim 1, wherein each securing region comprises the intersection of at least one raised tooth from a first member and at least one raised tooth from a second member

4. The interlocking grid of claim 3, wherein the slots of the first members project upward into the body and the teeth of the first members project upward from the body above the recesses.

5. The interlocking grid of claim 4, wherein the slots of the second members project downward into the body and each slot is bordered by two raised teeth projecting upward from the body immediately adjacent the corresponding recess, thereby forming repetitions of “tooth-slot-tooth” along the body.

6. The interlocking grid of claim 5, wherein the second members have a body height between “tooth-slot-tooth” repetitions of a, a body height at slots of b, each raised tooth has a height of c from the upper surface of the body, and each “tooth-slot-tooth” repetition has a length of d.

7. The interlocking grid structure of claim 6, wherein the first members have a body height between raised teeth of a′, each slot projects into the body of the longitudinal member for a distance of b′, each raised tooth has a height of c′ from the upper surface of the body, and each raised tooth has a length of d′.

8. The interlocking grid structure of claim 7, wherein a=a′, b=b′, c=c′ and d=d′.

9. The interlocking grid structure of claim 1, wherein each of the first and second members terminates at both ends with a protuberance.

10. The interlocking grid structure of claim 9, wherein the frame includes a plurality of apertures configured to receive the terminal protuberances of the first and second members.

11. The interlocking grid structure of claim 1, further comprising at least one spacer.

12. An interlocking grid structure comprising:
a plurality of first members arranged approximately parallel to each other and secured to the frame, the first members each comprising a body with a height of a′ and a plurality of slots projecting upward into the body for a distance of b′, each slot corresponding with a raised tooth projecting upward from the body a distance of c′, wherein the length of each raised tooth is d′;
a plurality of second members arranged approximately parallel to each other and approximately perpendicular to the first members, the second members each comprising a body having a height of a and a plurality of slots extending downward to the body such that the body has a height of b at the slots, each slot bordered on either said by a raised tooth projecting upward from the body a distance of c, thereby forming a plurality of “raised tooth/slot/raised tooth” repetitions across the length of the second members, wherein the length of each “raised tooth/slot/raised tooth” repetition is d;
wherein each slot of the first members corresponds to and interlocks with one slot of the second members; and
a plurality of securing regions comprising the intersection of at least one raised tooth from a first member and at least one raised tooth from a second member;
wherein at least one of the plurality of first members and at least one of the plurality of second members comprises a carbon fiber composite material.

13. The interlocking grid structure of claim 12, wherein the securing regions are pins.

14. The interlocking grid structure of claim 12, wherein the frame is either rectangular or circular.

15. A method of assembling an interlocking grid structure comprising:
providing a plurality of first members comprising a body, a plurality of slots and a plurality of raised teeth;
providing a plurality of second members comprising a body, a plurality of slots and a plurality of raised teeth;
aligning the first members above the second members such that slots of the first members align with slots of the second members; and
interlocking the first and second members with the corresponding slots, thereby forming a plurality of securing regions, each securing region comprising at least one raised tooth of a first member and at least one raised tooth of a second member.

16. The method of claim 15, wherein the aligning includes aligning the first members so as to be substantially perpendicular with the second members.

17. The method of claim 15, wherein the providing of the plurality of first members includes providing at least one of the plurality of first members to have a carbon fiber material and wherein the providing of the plurality of second members includes providing at least one of the plurality of second members to have a carbon fiber composite material.

18. An interlocking structure comprising:
a plurality of first members;
a plurality of second members arranged and interlocked with respect to the plurality of first members at a plurality of intersections, at least one of which comprises a raised securing region that is configured to support, engage and/or retain a part during heat-treating of the part.

19. The interlocking structure of claim 18 wherein each of the plurality of first members and each of the plurality of second members comprises a carbon fiber composite material.

20. The interlocking structure of claim 19, wherein the plurality of first members are approximately parallel to each other and optionally secured to a frame, each first member comprising a body, a plurality of slots and a plurality of raised teeth and wherein the plurality of second members are arranged approximately parallel to each other and optionally secured to the frame, each second member comprising a body, a plurality of slots and, optionally, a plurality of raised teeth, wherein the slots of the first members correspond to and interlock with the slots of the second members and such that a plurality of raised securing regions are provided, each comprising a raised tooth.

21. The interlocking structure of claim 18, wherein one or both of: (i) at least one of the plurality of first members includes a stepped region that, in conjunction with the raised tooth, is used to support the part during the heat-treating; and (ii) at least one of the plurality of second members includes a stepped region that, in conjunction with the raised tooth, is used to support the part during heat-treating.

22. The interlocking structure of claim 18, wherein the part is a metal part and the heat-treating is selected from one of the following processes: hardening, brazing, annealing, tempering and sintering.

23. The interlocking structure of claim 22 wherein the plurality of first members and the plurality of second members comprises a carbon fiber composite material.
